(19) United States
(12) Patent Application Publication
(10) Pub. No.: US 2026/0039070 A1
(43) Pub. Date: Feb. 5, 2026

(54) SHIELDED CONNECTOR

(71) Applicant: SUMITOMO WIRING SYSTEMS, LTD., Mie (JP)

(72) Inventor: Long CHEN, Mie (JP)

(21) Appl. No.: 19/272,342

(22) Filed: Jul. 17, 2025

(30) Foreign Application Priority Data
Jul. 31, 2024 (JP) 2024-124322

(51) Int. Cl. H01R 24/44

(52) U.S. Cl. CPC H01R 24/44; H01R 2201/26

(57) ABSTRACT

A outer conductor terminal includes a plurality of elastic contact portions elastically deformable in a radial direction orthogonal to a front-rear direction, and a plurality of slits located between the plurality of elastic contact portions in a circumferential direction of the outer conductor terminal. Each of the elastic contact portions includes a contact point portion protruding outward in the radial direction. The slits extend in the front-rear direction and are open at the front end of the outer conductor terminal. The outer conductor terminal includes, between the slits, stop portions that abut against the outer peripheral surface of a dielectric while the contact point portions are in contact with a counterpart outer conductor terminal.

### CROSS-REFERENCE TO RELATED APPLICATIONS

This application is based on and claims priority from Japanese Patent Application No. 2024-124322, filed on Jul. 31, 2024, with the Japan Patent Office, the disclosure of which is incorporated herein in its entirety by reference.

### TECHNICAL FIELD

The present disclosure relates to a shielded connector.

### BACKGROUND

The shielded connector described in JP 2024-013285 A includes an inner conductor terminal, a dielectric, and an outer conductor terminal. The outer conductor terminal includes a surrounding portion that surrounds the outer peripheral surface of the dielectric. The surrounding portion has a polygonal tube shape. The surrounding portion includes a plurality of elastic contact portions (not named in JP 2024-013285 A) that are cut and raised outward. Each of the elastic contact portions protrudes outward and comes into contact with a counterpart outer conductor terminal. Also, the outer conductor terminal includes a plurality of slits (not named in JP 2024-013285 A) at four corners of the surrounding portion. The slits extend rearward from the front end of the surrounding portion. When the contact point portions come into contact with the counterpart outer conductor terminal, plate piece portions between the slits of the surrounding portion are elastically deformed inward in the radial direction, namely toward the dielectric. In the space located on the inner side in the radial direction of the plate piece portion, a counterpart inner conductor terminal (not disclosed in JP 2024-013285 A) is to be disposed.

U.S. Pat. No. 10,944,218 discloses a structure in which an outer conductor ring (a portion denoted by reference numeral 300) is formed at the front end portion of an outer conductor main body (a portion denoted by reference numeral 200). The outer conductor ring maintains a constant ring shape due to welding applied on a welding seam (a portion denoted by reference numeral 209).

### SUMMARY

In JP 2024-013285 A, for example, when a shielded connector mounted in a vehicle or the like receives vibrations, the distance between the outer conductor terminal and the counterpart inner conductor terminal may change due to the plate piece portion on the distal end side of the surrounding portion vibrates so as to come close to and separate from the dielectric. If the amount of a change in characteristic impedance increases due to the change in the distance, there is concern that the transmission characteristics are influenced thereby.

In contrast, in U.S. Pat. No. 10,944,218, the amount of a change in characteristic impedance can be reduced due to the outer conductor ring having a constant shape. However, there is a problem in that a separate process and separate equipment for conducting welding on a welding seam is required, which leads to an increase in cost.

Therefore, it is an object of the present disclosure to provide a shielded connector capable of reducing the amount of change in impedance and improving the transmission characteristics.

A shielded connector of the present disclosure is a shielded connector including: an inner conductor terminal; a dielectric surrounding the inner conductor terminal; and a plate-shaped outer conductor terminal surrounding the inner conductor terminal, wherein the outer conductor terminal includes: a plurality of elastic contact portions elastically deformable in a radial direction orthogonal to a front-rear direction; and a plurality of slits located between the plurality of elastic contact portions in a circumferential direction of the outer conductor terminal, each of the plurality of electric contact portions includes a contact point portion protruding outward in the radial direction, the plurality of slits extend in the front-rear direction and are open at a front end of the outer conductor terminal, and the outer conductor terminal includes, between the plurality of slits, stop portions that abut against an outer peripheral surface of the dielectric while the contact point portions are in contact with a counterpart outer conductor terminal.

With the present disclosure, it is possible to provide a shielded connector capable of reducing the amount of change in impedance and improving the transmission characteristics.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a shielded terminal unit of a shielded connector according to Embodiment 1.

FIG. 2 is a perspective view of a first outer conductor terminal of the shielded connector according to Embodiment 1, as viewed from above.

FIG. 3 is a perspective view of an open-shaped second outer conductor terminal of the shielded connector according to Embodiment 1, as viewed from below.

FIG. 4 is a perspective view of an open-shaped shield support member of the shielded connector according to Embodiment 1, as viewed from above.

FIG. 5 is a diagram for illustrating a step of assembling the shielded connector according to Embodiment 1, which is a perspective view illustrating a state in which a sheath and the like are peeled at the front end portion of a shielded electric wire.

FIG. 6 is a diagram for illustrating a step of assembling the shielded connector according to Embodiment 1, which is another perspective view illustrating a state in which the open-shaped shield support member is disposed on the outer peripheral surface of the shield portion.

FIG. 7 is a diagram for illustrating a step of assembling the shielded connector according to Embodiment 1, which is another perspective view illustrating a state in which the shield support member surrounds the shield portion.

FIG. 8 is a diagram for illustrating a step of assembling the shielded connector according to Embodiment 1, which is another perspective view illustrating a state in which a folded-back portion is formed by folding back the shield portion rearward and core wires are exposed by removing the front end portions of insulating coatings of internal electric wires.

FIG. 9 is a diagram for illustrating a step of assembling the shielded connector according to Embodiment 1, which is another perspective view illustrating a state in which inner conductor terminals are attached to the front end portions of the internal electric wires.

FIG. 10 is a diagram for illustrating a step of assembling the shielded connector according to Embodiment 1, which is another perspective view illustrating a state in which a first dielectric and a second dielectric are respectively disposed on the upper and lower sides of the internal electric wires, so that the internal electric wires are sandwiched therebetween.

FIG. 11 is a diagram for illustrating a step of assembling the shielded connector according to Embodiment 1, which is another perspective view illustrating a state in which the first dielectric and the second dielectric are attached to each other.

FIG. 12 is a diagram for illustrating a step of assembling the shielded connector according to Embodiment 1, which is another perspective view illustrating a state in which the dielectrics are inserted into a surrounding portion of the first outer conductor terminal.

FIG. 13 is a diagram for illustrating a step of assembling the shielded connector according to Embodiment 1, which is another perspective view illustrating a state in which the first outer conductor terminal is disposed on the outer peripheral surface of the second outer conductor terminal.

FIG. 14 is a diagram for illustrating a step of assembling the shielded connector according to Embodiment 1, which is another perspective view illustrating a state in which first to third portions are crimped to a range from the folded-back portion of the shield portion to the front end portion of the sheath in the shielded electric wire.

FIG. 15 is an enlarged cross-sectional plan view illustrating a state in which stopper portions of protrusions of the third portion face counterpart stopper portions of recessed portions of the shield support member in the shielded connector according to Embodiment 1.

FIG. 16 is a cross-sectional view of the shielded connector according to Embodiment 1 taken along line A-A in FIG. 15.

FIG. 17 is an enlarged side view illustrating a state in which the shielded connector according to Embodiment 1 is fitted to a counterpart shielded connector, contact point portions of elastic contact portions of the first outer conductor terminal are in contact with a counterpart outer conductor terminal, stop portions are in contact with the dielectrics, and the stop portions are spaced apart a predetermined distance from a counterpart inner conductor terminal.

FIG. 18 is a cross-sectional view of the shielded connector according to Embodiment 1 taken along line B-B in FIG. 17.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.
(1) A shielded connector of the present disclosure includes: an inner conductor terminal; a dielectric surrounding the inner conductor terminal; and a plate-shaped outer conductor terminal surrounding the inner conductor terminal, wherein the outer conductor terminal includes: a plurality of elastic contact portions elastically deformable in a radial direction orthogonal to a front-rear direction; and a plurality of slits located between the plurality of elastic contact portions in a circumferential direction of the outer conductor terminal, each of the plurality of electric contact portions includes a contact point portion protruding outward in the radial direction, the plurality of slits extend in the front-rear direction and are open at a front end of the outer conductor terminal, and the outer conductor terminal includes, between the plurality of slits, stop portions that abut against an outer peripheral surface of the dielectric while the contact point portions are in contact with a counterpart outer conductor terminal.

In the state in which the contact point portions are in contact with the counterpart outer conductor terminal, the movement of the elastic contact portions can be suppressed due to the stop portions of the outer conductor terminal abutting against the outer peripheral surface of the dielectric, thus making it possible to maintain the distance in the front-rear direction between a counterpart inner conductor terminal disposed in the space inside in the radial direction relative to the stop portions and the outer conductor terminal. Accordingly, the amount of change in the characteristic impedance can be reduced, and the transmission characteristics can be improved. In particular, since merely the stop portions are formed between the slits of the outer conductor terminal, it is possible to avoid the step of forming the stop portion from becoming complicated, thus making it possible to suppress an increase in cost.
(2) It is preferable that, in the shielded connector according to (1) above, each of the stop portions has a straight shape extending in the front-rear direction in a cross-sectional view taken in the front-rear direction.

With the configuration of (2) above, it is possible to effectively suppress a change in the characteristic impedance within a range of the length of the stop portions extending in the front-rear direction.
(3) It is preferable that, in the shielded connector according to (2) above, the stop portions are in surface contact with the outer peripheral surface of the dielectric while the contact point portions are in contact with the counterpart outer conductor terminal.

With the configuration of (3) above, even when the shielded connector is placed under vibration conditions, the movement of the elastic contact portions can be reliably suppressed, thus making it possible to more reliably maintain the state in which the stop portions abut against the outer peripheral surface of the dielectric.
(4) It is preferable that, in the shielded connector according to any one of (1) to (3) above, each of the stop portions includes a portion protruding forward from a front end of the dielectric.

With the configuration of (4) above, even when the shielded electric wire is, for example, pulled rearward in the state in which the shielded connector and a counterpart shielded connector are fitted to each other, and a gap is formed between the dielectric and a counterpart dielectric in the front-rear direction, it is possible to maintain the state in which the stop portions surround the outer peripheral surface of the counterpart inner conductor terminal. Accordingly, it is possible to more reliably suppress a change in the characteristic impedance between the dielectric and the counterpart dielectric.

### Details of Embodiments of the Present Disclosure

The following describes specific embodiments of the present disclosure with reference to the drawings. Note that the present invention is not limited to these embodiments and is defined by the scope of the appended claims, and all changes that fall within the same essential spirit as the scope of the claims are intended to be included therein.

### Embodiment 1

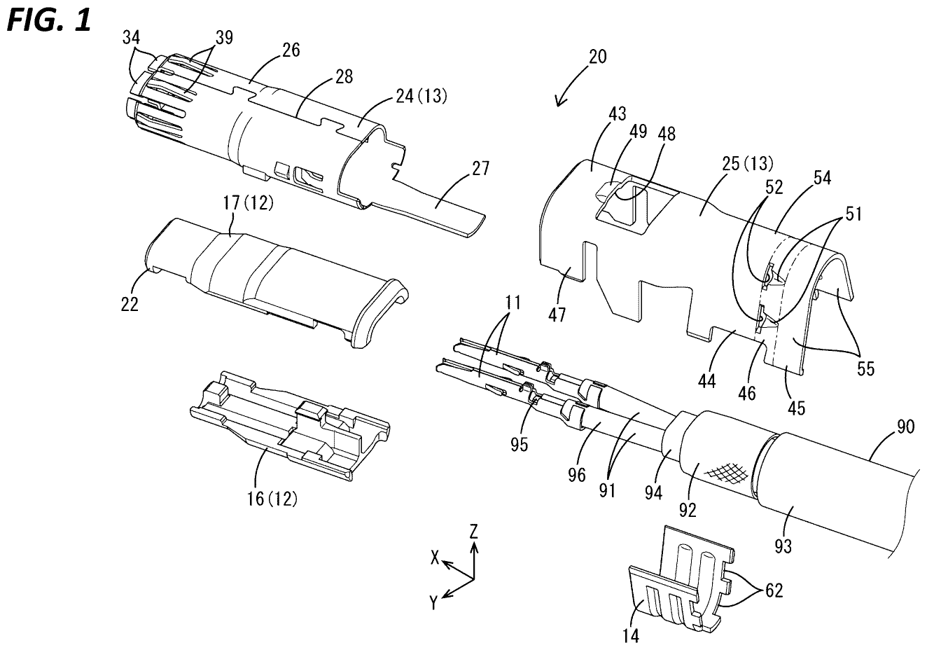

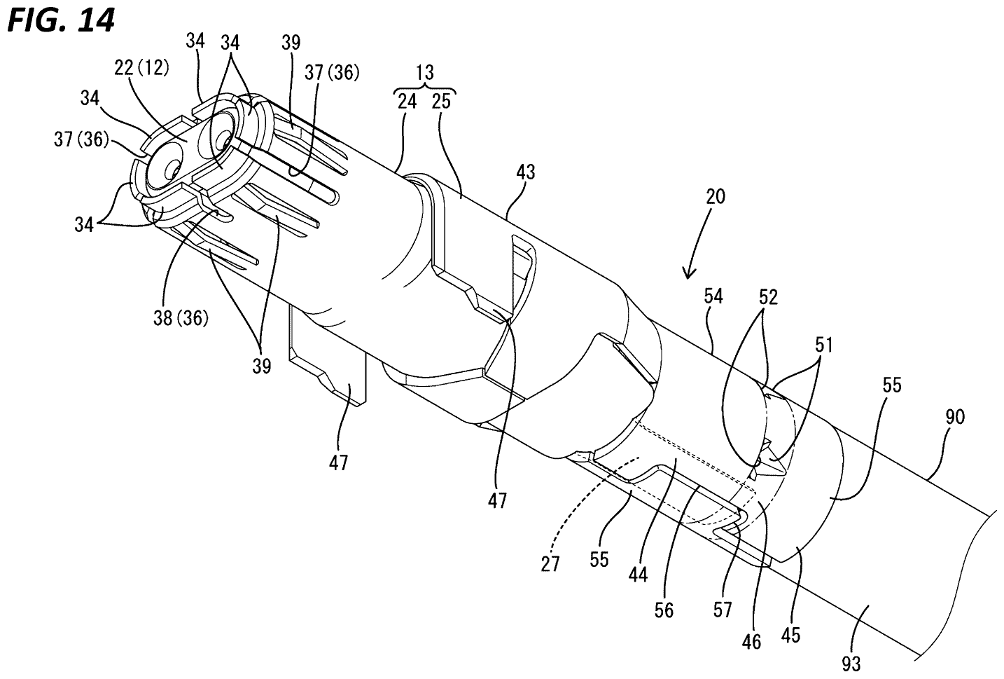

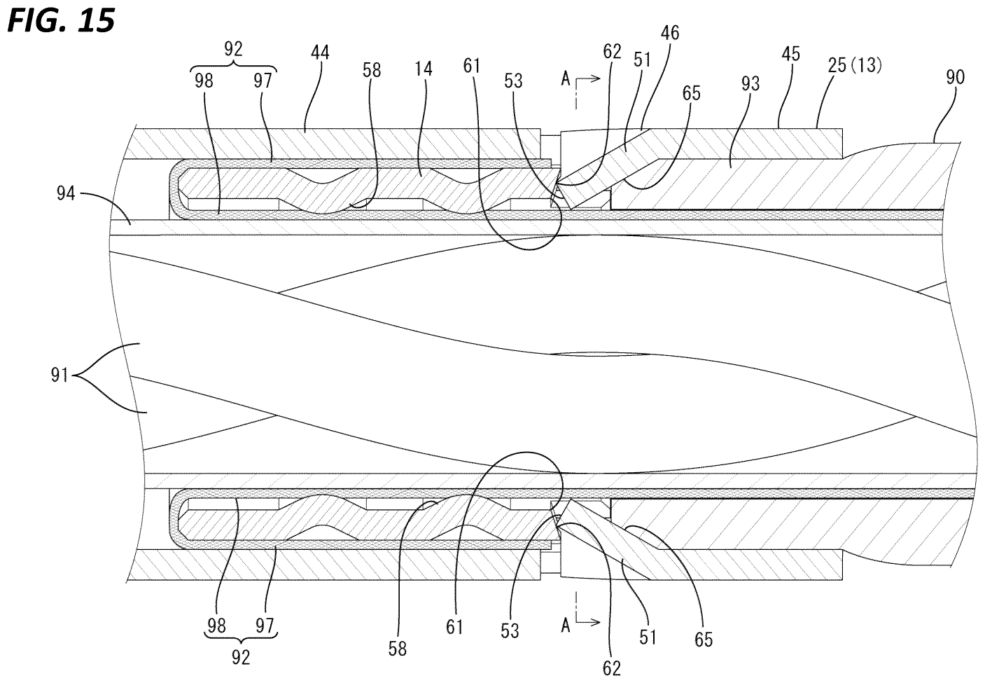

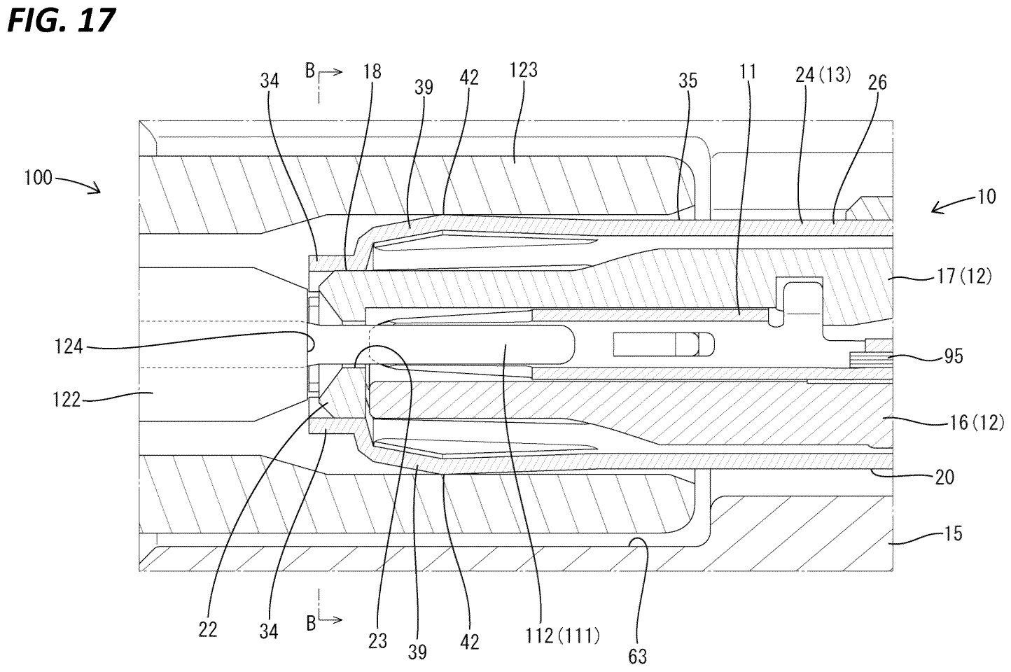

As shown in FIGS. 1 and 17, a shielded connector 10 according to Embodiment 1 of the present disclosure includes inner conductor terminals 11, a dielectric 12, an outer conductor terminal 13, a shield support member 14 (not illustrated in FIG. 17), and a housing 15 (not illustrated in FIG. 1). The inner conductor terminals 11, the outer conductor terminal 13, and the shield support member 14 are each formed by, for example, bending a conductive metal plate material. The dielectric 12 and the housing 15 are each formed using an insulating resin material. The housing 15 is to be fitted to a counterpart shielded connector 100. The inner conductor terminals 11 and the outer conductor terminal 13 are electrically connected to the terminus of a shielded electric wire 90. At the terminus of the shielded electric wire 90, the inner conductor terminals 11, the dielectric 12, the outer conductor terminal 13, and the shield support member 14 are attached to one another to form a shielded terminal unit 20 (see FIG. 14). As shown in FIG. 17, the shielded terminal unit 20 is housed in the housing 15. Note that, in the following description, the side from which the shielded connector 10 is fitted to the counterpart shielded connector 100 is defined as the front side in the front-rear direction. The terminus of the shielded electric wire 90 corresponds to the front end portion of the shielded electric wire 90. The vertical direction is based on the vertical direction of the drawings other than FIG. 15. The left-right direction is based on the left-right direction as viewed from the front side. In FIG. 1, arrows X, Y and Z indicate the front side, the right side, and the upper side, respectively. The reference directions do not necessarily coincide with the corresponding directions when the shielded connector 10 is mounted in a vehicle or the like (not illustrated).

### (Shielded Electric Wire 90)

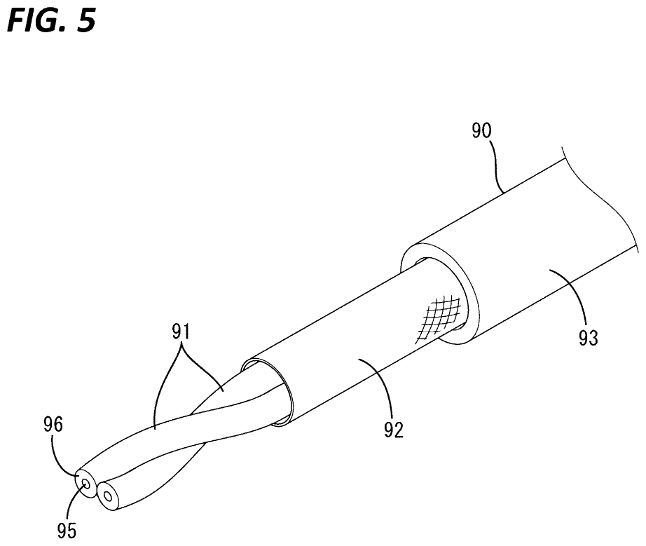

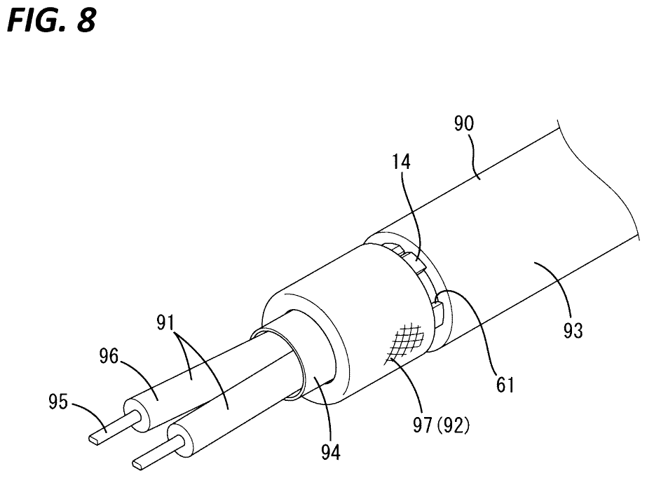

As shown in FIG. 5, the shielded electric wire 90 of Embodiment 1 includes two internal electric wires 91, a shield portion 92 that collectively surrounds the internal electric wires 91, and an insulating sheath 93 that covers the outer peripheral surface of the shield portion 92. Each of the internal electric wires 91 is a coated electric wire obtained by coating a core wire 95 with an insulating coating 96. The internal electric wires 91 are twisted with each other to form a twisted pair wire. The shield portion 92 is a flexible conductive member. Here, the shield portion 92 is configured as a braided wire formed by braiding conductive strands made of copper, aluminum, or the like into a tubular shape. As shown in FIG. 8, an insulating member 94 is provided between the internal electric wires 91 and the shield portion 92.

At the front end portion of the shielded electric wire 90, the sheath 93 is removed, and the internal electric wires 91, the insulating member 94, and the shield portion 92 are sequentially exposed. Furthermore, at the front end portions of the internal electric wires 91, the insulating coating 96 is removed, and the core wire 95 is exposed.

As shown in FIG. 15, on the front side with respect to the sheath 93, the shield support member 14 surrounds the front end portion of the shielded electric wire 90 and is held by the shielded electric wire 90. The front end portion of the shield portion 92 is disposed so as to extend from the inner peripheral surface of the shield support member 14 to the outer peripheral surface thereof via the front side of the shield support member 14. The shield portion 92 includes a folded-back portion 97 that is folded back toward the outer peripheral surface of the shield support member 14, and an inner peripheral portion 98 that is disposed on the inner peripheral surface side of the shield support member 14 and extends along the outer peripheral surface of the insulating member 94.

### (Inner Conductor Terminal 11)

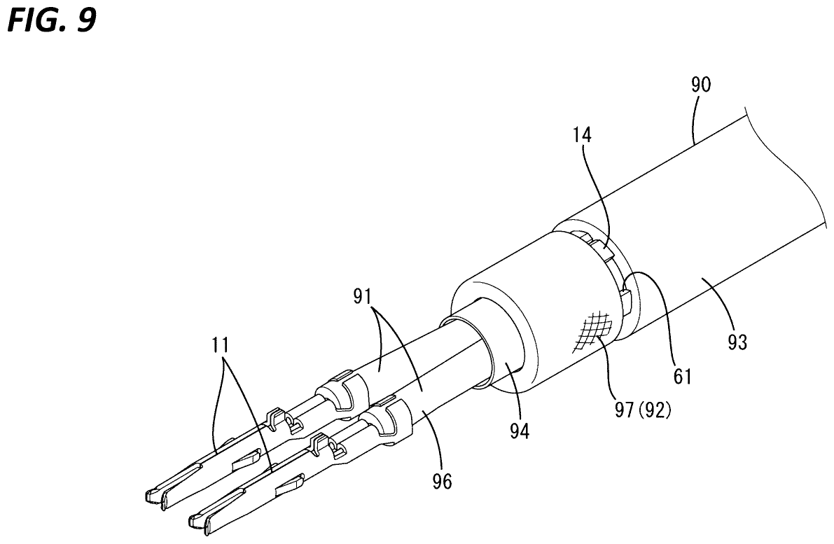

As shown in FIGS. 1 and 9, the inner conductor terminal 11 of Embodiment 1 is formed by bending a metal plate and has a shape elongated in the front-rear direction. As shown in FIG. 17, a tab 112 of a counterpart inner conductor terminal 111 is fitted and electrically connected to the front end portion of the inner conductor terminal 11. As shown in FIG. 1, the rear end portion of the inner conductor terminal 11 is crimped and electrically connected to the exposed core wire 95 of the internal electric wire 91, and is mechanically connected to the insulating coating 96.

### (Dielectric 12)

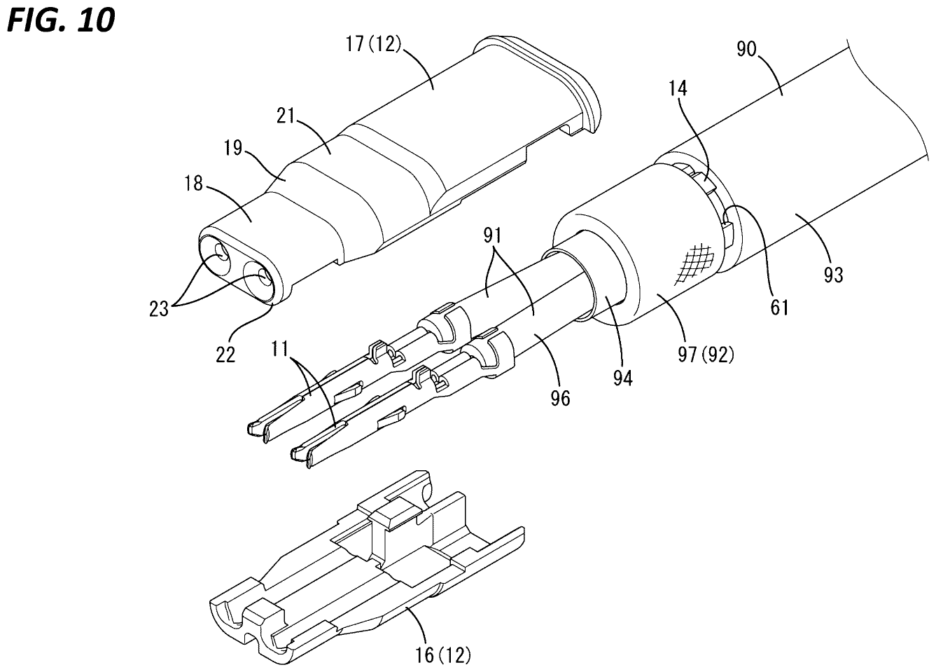

As shown in FIGS. 1 and 10, the dielectric 12 of Embodiment 1 is constituted by a first dielectric 16 and a second dielectric 17. The second dielectric 17 is attached to the first dielectric 16 from above. The inner conductor terminals 11 are housed between the first dielectric 16 and the second dielectric 17 and are lined up in the left-right direction. Similarly, after untwisted, the front end portions of the internal electric wire 91 are housed between the first dielectric 16 and the second dielectric 17 and are lined up in the left-right direction.

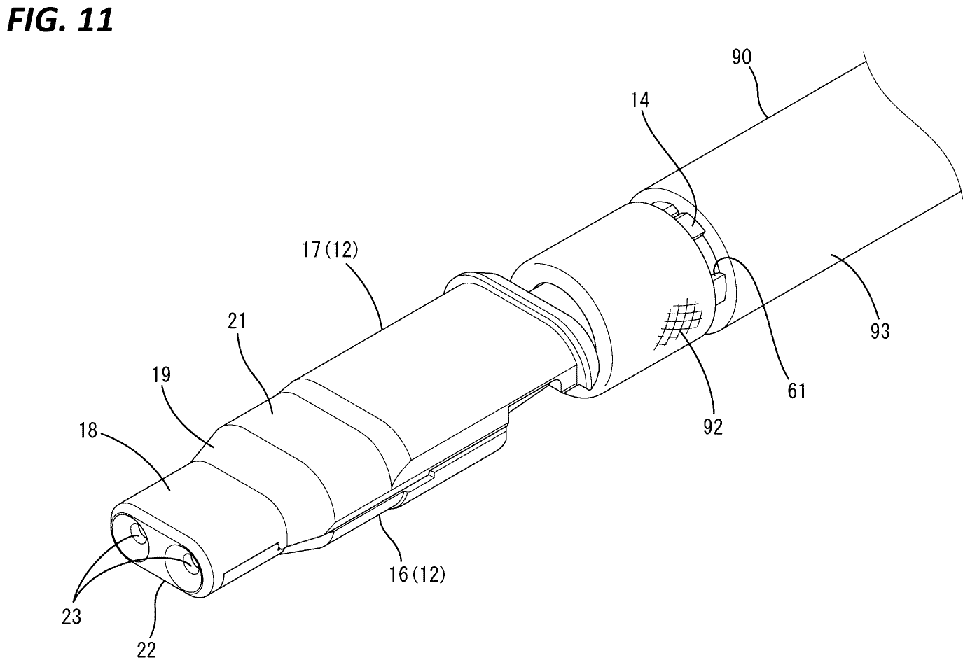

As shown in FIG. 11, the front end portion of the outer peripheral surface of the dielectric 12 (the first dielectric 16 and the second dielectric 17) is configured as a peripheral surface portion 18 extending in the front-rear direction. The peripheral surface portion 18 of the dielectric 12 has four rounded corners in a front view, and its outer peripheral surface has a shape that is longer in the left-right direction than in the vertical direction. The outer peripheral surface of the dielectric 12 includes, in addition to the peripheral surface portion 18, a slope portion 19 whose diameter increases rearward from the peripheral surface portion 18, and a rear surface portion 21 that extends rearward from the slope portion 19.

The second dielectric 17 includes a front wall portion 22 that forms a front wall part of the dielectric 12. The front wall portion 22 includes a pair of left and right tab insertion holes 23. The tab insertion holes 23 pass through the front wall portion 22 in the front-rear direction. As shown in FIG. 17, the tab 112 of the counterpart inner conductor terminal 111 is inserted through the tab insertion hole 23 from the front side, and is inserted into and electrically connected to the corresponding inner conductor terminal 11. The front surface of the front wall portion 22 is disposed so as to face a counterpart dielectric 122 of the counterpart shielded connector 100. Note that the counterpart inner conductor terminals 111 are housed in the counterpart dielectric 122. The tab 112 protrudes from the counterpart dielectric 122 toward the tab insertion hole 23.

### (Outer Conductor Terminal 13)

As shown in FIG. 1, the outer conductor terminal 13 of Embodiment 1 is constituted by a first outer conductor terminal 24 and a second outer conductor terminal 25. The first outer conductor terminal 24 includes a surrounding portion 26 that surrounds the outer peripheral surface of the dielectric 12, and an extension portion 27 that extends rearward from the surrounding portion 26.

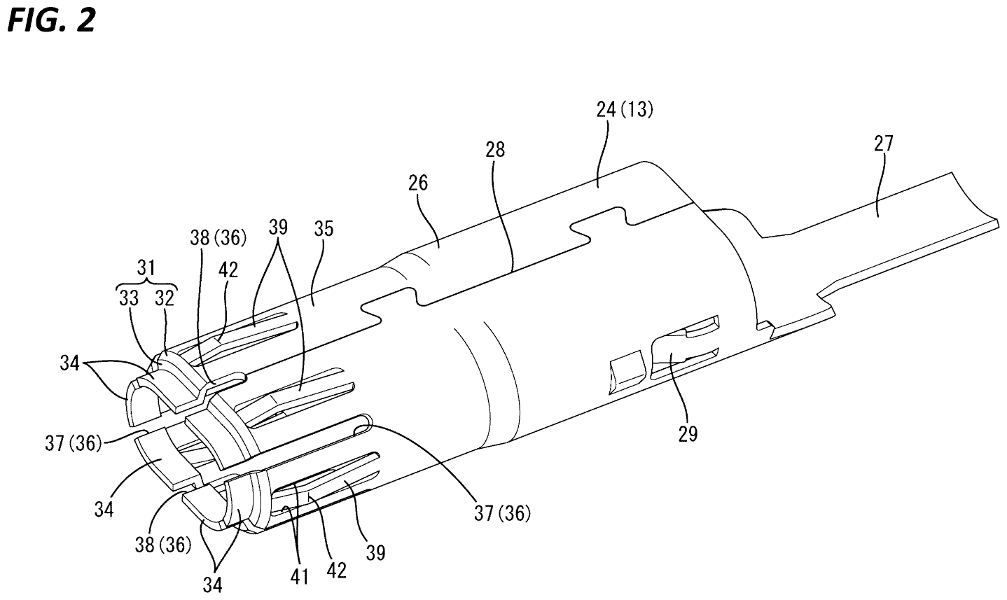

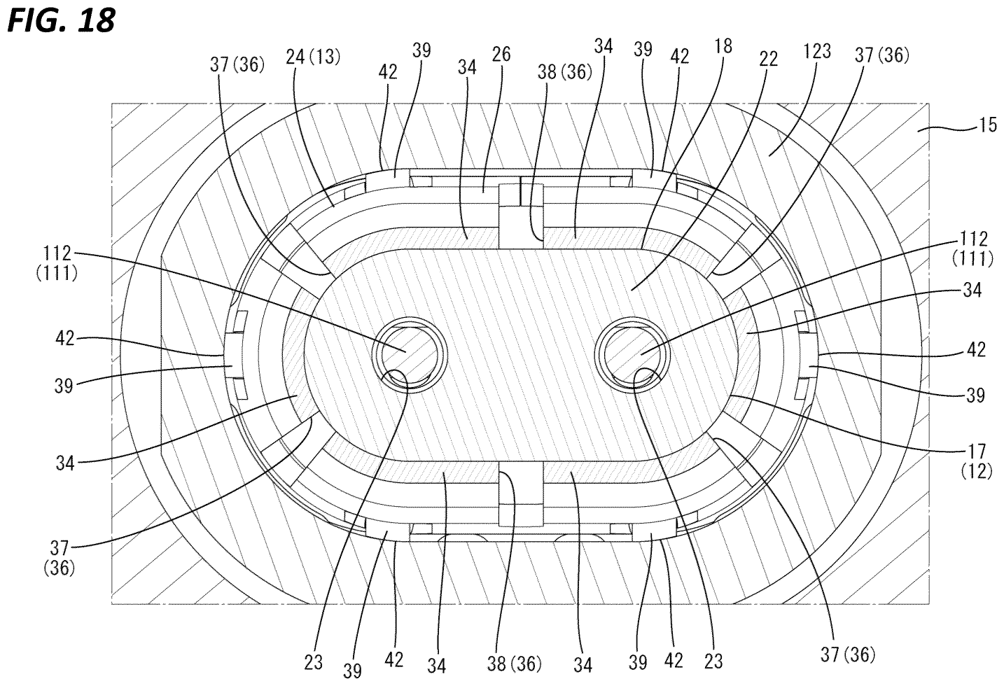

As shown in FIGS. 2 and 18, the surrounding portion 26 has four rounded corners in a front view, and has a cylindrical shape that is longer in the left-right direction than in the vertical direction. The dielectric 12 is inserted into the surrounding portion 26 from behind. The outer conductor terminal 13 and the inner conductor terminal 11 are insulated from each other by the dielectric 12. As shown in FIG. 2, both ends in the circumferential direction of the surrounding portion 26 include engagement edges 28 that have protrusions and recessed portions and are engaged with each other at the central portion in the left-right direction of the upper wall portion. The cylindrical shape of the surrounding portion 26 is maintained due to the engagement edges 28.

As shown in FIG. 2, the first outer conductor terminal 24 includes a pair of dislodgement preventing portions 29 (only one of them is illustrated in FIG. 2) at left and right end portions of the rear end portion of the surrounding portion 26. The dislodgement preventing portions 29 are locked to the dielectric 12. The dislodgement preventing portions 29 suppress rearward dislodgement of the dielectric 12 from the surrounding portion 26.

The first outer conductor terminal 24 includes a step portion 31 at the front end portion of the surrounding portion 26. The step portion 31 is constituted by an inclination portion 32 whose diameter decreases inward in the radial direction as it extends forward, and an elevation surface portion 33 that extends inward in the radial direction from the front end of the inclination portion 32. The elevation surface portion 33 is formed to rise more steeply by setting the inclination angle of the elevation surface portion 33 relative to the front-rear direction to be larger than that of the inclination portion 32.

Regarding front and rear portions of the surrounding portion 26 between which the step portion 31 is sandwiched, the front portion is constituted by a plurality of stop portions 34, and the rear portion is configured as a peripheral wall portion 35.

The stop portions 34 constitute the front end portion of the surrounding portion 26, and are separated from one another in the circumferential direction with slits 36, which will be described below, being located therebetween. Each of the stop portions 34 has a plate piece shape extending in the circumferential direction, and is located inside in the radial direction relative to the peripheral wall portion 35. As shown in FIG. 17, in the cross-sectional view taken in the front-rear direction, the stop portion 34 has a straight shape extending in the front-rear direction. The tabs 112 of the counterpart inner conductor terminals 111 are to be disposed in the space inside in the radial direction relative to the stop portions 34. In Embodiment 1, the distances (separation distances in the radial direction) between the tabs 112 of the counterpart inner conductor terminals 111 and the stop portions 34 are set to be constant as viewed in the front-rear direction.

As shown in FIGS. 2 and 18, the surrounding portion 26 includes a plurality of slits 36 extending in the front-rear direction. The slits 36 are disposed in the surrounding portion 26 at intervals, specifically irregular intervals, in the circumferential direction. As shown in FIG. 2, the slits 36 extend in the front-rear direction, and specifically, the slits 36 are formed to extend in the front-rear direction in a range from the stop portions 34 to the peripheral wall portion 35 via the step portion 31. The front ends of the slits 36 are open at the front end of the surrounding portion 26. The stop portions 34 are elastically deformable in the radial direction using, as fulcra, portions of the peripheral wall portion 35 that correspond to the rear ends of the slits 36.

In Embodiment 1, as shown in FIGS. 2 and 18, the slits 36 include four first slits 37 formed at the four corners of the surrounding portion 26, and two second slits 38 formed at the central portions in the left-right direction of the upper wall portion and the lower wall portion of the surrounding portion 26. The first slits 37 are cut into a shape more elongated in the front-rear direction compared with the second slits 38. The rear ends of the first slits 37 are disposed at the same positions as those of elastic contact portions 39, which will be described below, or at positions on the rear side relative to the rear ends of the elastic contact portions 39, in the front-rear direction. The rear ends of the second slits 38 are located at positions corresponding to the front end portions of the elastic contact portions 39 in the front-rear direction.

As shown in FIGS. 2 and 18, the surrounding portion 26 includes a plurality of elastic contact portions 39 on the upper wall portion, the lower wall portion, and left and right side wall portions. As shown in FIGS. 2, 14, and 18, on the upper wall portion and the lower wall portion, a pair of left and right elastic contact portions 39 are each formed between the first slit 37 and the second slit 38. Also, on each of the side wall portions, one elastic contact portion 39 is formed between the first slits 37.

As shown in FIG. 2, each of the elastic contact portions 39 is formed by cutting and raising a portion between a pair of notches 41 formed in the peripheral wall portion 35 into a convex shape protruding outward in the radial direction. Each of the notches 41 linearly extends in the front-rear direction in the peripheral wall portion 35. The elastic contact portion 39 is formed between the notches 41 in the form of a beam supported at both ends in the front-rear direction that serve as fixed ends. The elastic contact portion 39 is elastically deformable in the radial direction in the peripheral wall portion 35. The elastic contact portion 39 includes a contact point portion 42 protruding outward in the radial direction. The contact point portion 42 corresponds to the top of the elastic contact portion 39. As shown in FIG. 17, a counterpart outer conductor terminal 123 of the counterpart shielded connector 100 is to be fitted onto the outer peripheral surface of the surrounding portion 26. The contact point portions 42 of the elastic contact portions 39 come into contact with the inner peripheral surface of the counterpart outer conductor terminal 123. The outer conductor terminal 13 and the counterpart outer conductor terminal 123 are electrically connected to each other due to the shielded connector 10 and the counterpart shielded connector 100 being fitted to each other.

As shown in FIG. 2, the extension portion 27 has a band shape extending rearwardly from the lower wall portion of the peripheral wall portion 35. Barrel pieces 55, which will be described below, of the second outer conductor terminal 25 are attached to the outer peripheral surface of the extension portion 27. The lower end portion of the folded-back portion 97 of the shield portion 92 is sandwiched and held between the extension portion 27 and the barrel pieces 55, which will be described below, of the second outer conductor terminal 25.

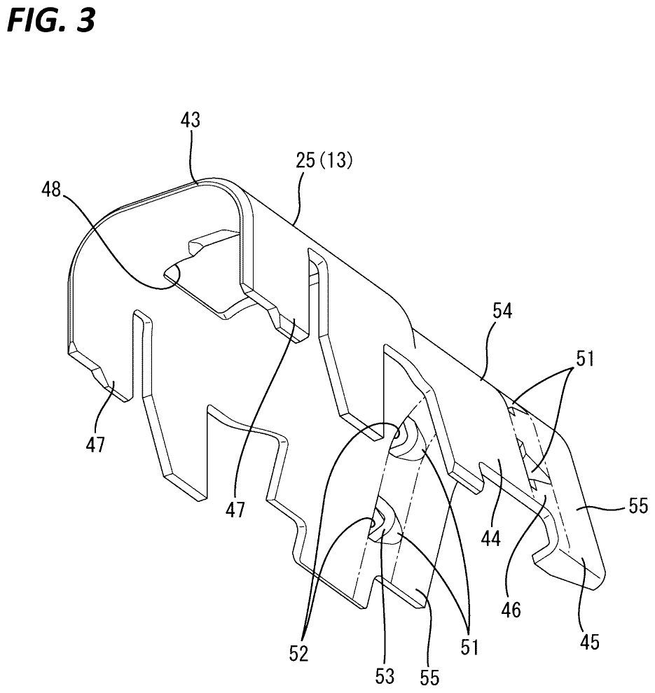

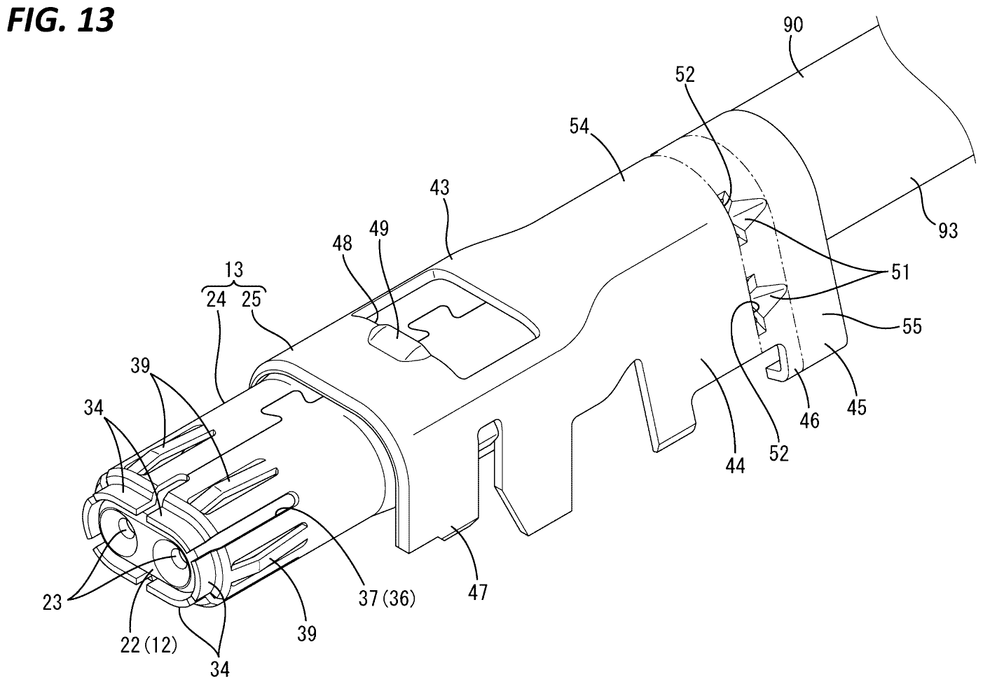

As shown in FIG. 13, the second outer conductor terminal 25 has a cover shape and is attached to the rear portion of the first outer conductor terminal 24 from above. As shown in FIGS. 1 and 3, the second outer conductor terminal 25 includes an engaging portion 43, a first portion 44, a third portion 46, and a second portion 45 in this order from the front end of the second outer conductor terminal 25 to the rear side. As shown in FIG. 3, the engaging portion 43 has a gate shape in the front view, and includes a pair of side plate portions 47 that face each other in the left-right direction. The side plate portions 47 are located at the front end portion of the second outer conductor terminal 25. The side plate portions 47 are inserted into guiding grooves (not illustrated) of the housing 15 to guide attachment of the outer conductor terminal 13 to the housing 15. As shown in FIGS. 1 and 13, the engaging portion 43 includes a lance hole 48 that is an opening having a rectangular shape in a plan view, and a locking protrusion 49 that is bent and raised from the front end portion of the lance hole 48. A lance (not illustrated) of the housing 15 enters the lance hole 48 of the engaging portion 43 and is locked to the locking protrusion 49, thereby suppressing rearward dislodgement of the outer conductor terminal 13 from the housing 15.

The shapes of the first portion 44, the second portion 45, and the third portion 46 are a U-shape (open shape; see FIGS. 1, 3, and 13) before they are crimped to the shielded electric wire 90, and are changed to an O-shape (closed shape; see FIGS. 14 to 16) after they are crimped thereto. Note that the following descriptions regarding the first portion 44, the second portion 45, and the third portion 46 are based on the state after they are crimped unless otherwise stated.

As shown in FIG. 15, the first portion 44 is crimped and electrically connected to the folded-back portion 97 of the shield portion 92. The folded-back portion 97 of the shield portion 92 is sandwiched and held between the first portion 44 and the shield support member 14. The first portion 44 has a cylindrical shape and surrounds the entire outer peripheral surface of the folded-back portion 97 of the shield portion 92.

The second portion 45 is crimped and mechanically connected to the sheath 93 of the shielded electric wire 90. The second portion 45 has a cylindrical shape and surrounds the entire outer peripheral surface of the sheath 93.

As shown in FIG. 15, the third portion 46 is located between the first portion 44 and the second portion 45 in the front-rear direction. The third portion 46 has a cylindrical shape and is disposed so as to cover an area in front of the front end portion of the sheath 93 of the shielded electric wire 90. As shown in FIG. 14, the third portion 46 has the same diameter as those of the first portion 44 and the second portion 45, and is flush therewith in the front-rear direction. The first portion 44 is disposed in front of a cut hole 52, which will be described below. The second portion 45 is disposed behind a protrusion 51, which will be described below. In this specification, the boundaries between the first portion 44, the second portion 45, and the third portion 46 (see dashed lines in FIG. 14) are set at positions in front of and behind the cut hole 52 and the protrusion 51.

The third portion 46 includes a plurality of protrusions 51. The protrusions 51 are disposed on the third portion 46 at intervals, specifically irregular intervals, in the circumferential direction. In Embodiment 1, a pair of upper and lower protrusions 51 are disposed at positions that can be seen from each of the left and right sides.

As shown in FIGS. 1 and 3, each of the protrusions 51 is formed by cutting and raising a portion behind the cut hole 52 formed in the third portion 46 so as to bulge inward in the radial direction of the third portion 46. Each of the cut holes 52 linearly extends in the circumferential direction of the third portion 46. The protrusion 51 is continuous with the adjacent portions in the third portion 46 without gaps with the exception of the cut hole 52. The protrusion 51 has a triangular shape as viewed from the outside in the radial direction, and gradually expands in the circumferential direction toward the front side where the cut hole 52 is located. As shown in FIG. 15, in the cross-sectional view taken in the front-rear direction, the protrusion 51 is inclined inward in the radial direction while extending forward.

As shown in FIG. 15, the front end surface of the protrusion 51 is configured as a stopper portion 53 that can abut against a counterpart stopper portion 62, which will be described below, of the shield support member 14 from behind. As shown in FIG. 3, the stopper portion 53 corresponds to a thick portion of the third portion 46, and is formed by cutting and raising a portion from the cut hole 52. The stopper portion 53 has a curved shape and protrudes inward in the radial direction of the third portion 46. The stopper portion 53 of the protrusion 51 extends in the circumferential direction along the cut hole 52. As shown in FIG. 15, the stopper portion 53 extends in a direction orthogonal to the inclination direction of the protrusion 51 and is inclined with respect to the radial direction.

As shown in FIGS. 1 and 3, a portion constituted by the first portion 44, the second portion 45, and the third portion 46 includes a base portion 54 extending in the front-rear direction, and a pair of left and right barrel pieces 55 (see FIG. 3) that protrude downward from the base portion 54 when not being crimped. The base portion 54 and the barrel pieces 55 are continuous with each other in the front-rear direction without gaps with the exception of the cut holes 52, and are shared by the first portion 44, the second portion 45, and the third portion 46. As shown in FIG. 14, the barrel pieces 55 are wound around the shielded electric wire 90. Both ends in the circumferential direction of the barrel pieces 55, which are the lower end portions of the first portion 44, the second portion 45, and the third portion 46, are fitting ends 56 that have protrusions and recessed portions and that are to be fitted to each other. The fitting ends 56 of the barrel pieces 55 each include, in the third portion 46, an inclined edge 57 inclined in a direction intersecting the circumferential direction. The closed shapes (tubular shapes) of the first portion 44, the second portion 45, and the third portion 46 is maintained due to locking function of the inclined edges 57 of the fitting ends 56.

### (Shield Support Member 14)

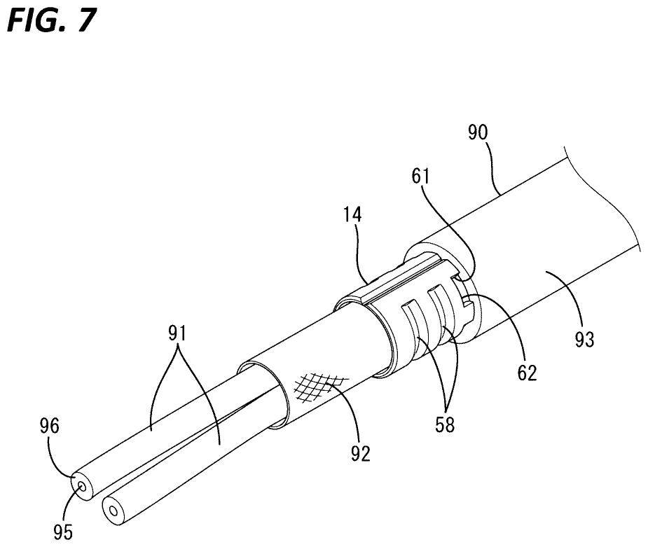

The shape of the shield support member 14 of Embodiment 1 is a U-shape (open shape; see FIGS. 1, 4, and 6) before it is crimped to the shielded electric wire 90, and is changed to an O-shape (closed shape; see FIGS. 7, 15, and 16) after it is crimped thereto. Note that the following description regarding the shield support member 14 is based on the state after it is crimped unless otherwise stated.

As shown in FIG. 7, the shield support member 14 has a cylindrical shape. Both ends in the circumferential direction of the shield support member 14 face each other at the upper end portions of the shield support member 14 so as to be capable of abutting against each other in the front-rear direction. As shown in FIG. 15, the folded-back portion 97 of the shield portion 92 receives a crimping force from the first portion 44 and comes into intimate contact with the outer peripheral surface of the shield support member 14. On the outer peripheral surface of the insulating member 94, the shield support member 14 comes into contact with the inner peripheral portion 98 of the shield portion 92.

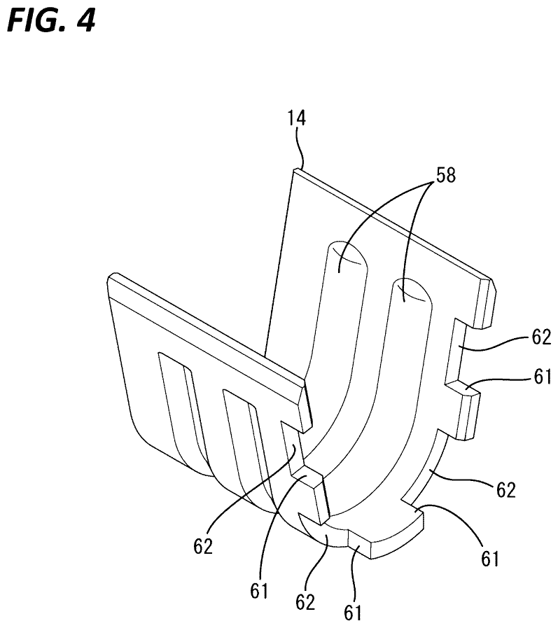

As shown in FIGS. 4, 6, and 7, the shield support member 14 includes a plurality of ribs 58. On the shield support member 14, the ribs 58 are spaced apart from each other in the front-rear direction and extend in the circumferential direction. Both ends of each of the ribs 58 in the circumferential direction reach the vicinities of the upper end portions of the shield support member 14. The ribs 58 protrude inward in the radial direction of the shield support member 14 and come into contact with the inner peripheral portion 98 of the shield portion 92 (see FIG. 15).

As shown in FIG. 4, the shield support member 14 includes a plurality of recessed portions 61. Each of the recessed portions 61 has a rectangular recessed shape as viewed from the outside in the radial direction, and is open at the rear end of the shield support member 14. The recessed portions 61 are disposed in the shield support member 14 at intervals, specifically irregular intervals, in the circumferential direction. The protrusions 51 of the third portion 46 are located in the recessed portions 61 of the outer conductor terminal 13 when the outer conductor terminal 13 is crimped.

The interior end surface (the end surface that is located on the front side and face rearward) of each of the recessed portions 61 is configured as a counterpart stopper portion 62. The counterpart stopper portion 62 of the recessed portion 61 extends in the circumferential direction. As shown in FIG. 15, the counterpart stopper portion 62 of the recessed portion 61 is gradually inclined rearward from the inside to the outside in the radial direction (the thickness direction of the shield support member 14). Right and left surfaces (surfaces facing each other in the left-right direction) of the recessed portion 61 are orthogonal to the counterpart stopper portion 62.

### (Housing 15)

Although details are not illustrated, the housing 15 of Embodiment 1 includes a fitting portion 63 that passes through the housing 15 in the front-rear direction, as shown in FIG. 17. The shielded terminal unit 20 is inserted into the fitting portion 63 of the housing 15 from behind. The housing 15 includes a lance (not illustrated) capable of being locked to the locking protrusion 49 of the second outer conductor terminal 25.

### (Functions of Shielded Connector 10)

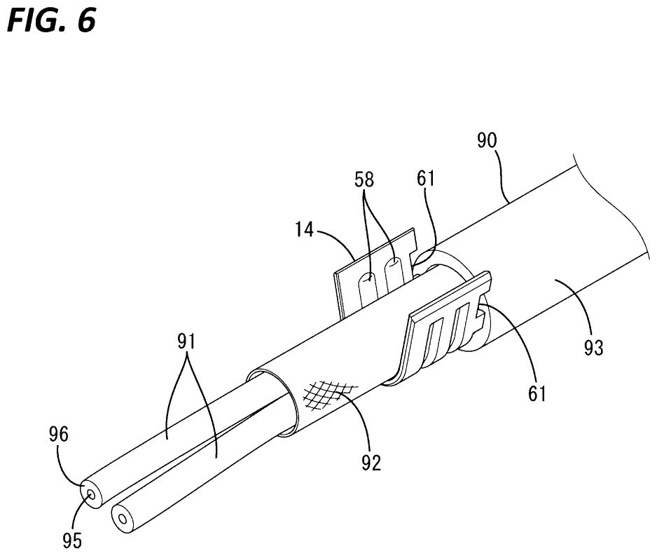

The following describes the procedure for assembling the shielded connector 10. First, as shown in FIG. 5, the sheath 93 is peeled at the front end portions of the shielded electric wire 90 to expose the shield portion 92 and the internal electric wires 91 on the front side relative to the sheath 93. Subsequently, as shown in FIG. 6, the open-shaped shield support member 14 is disposed on the front side relative to the sheath 93. In this state, as shown in FIG. 7, the shield support member 14 is crimped, so that the shield support member 14 surrounds the outer peripheral surface of the shield portion 92. Subsequently, as shown in FIG. 8, the front end portion of the shield portion 92 is inverted rearward, and the folded-back portion 97 of the shield portion 92 is positioned on the outer peripheral surface of the shield support member 14. At appropriate timing, the internal electric wires 91 are untwisted, and the insulating coatings 96 are removed to expose the core wires 95 at the front end portions of the internal electric wires 91. Note that the shield support member 14 is located on the front side relative to the front end of the sheath 93, and a gap may be formed between the shield support member 14 and the sheath 93.

Subsequently, as shown in FIG. 9, the inner conductor terminals 11 are electrically and mechanically crimped and connected to the front end portions of the internal electric wires 91. Furthermore, as shown in FIGS. 10 and 11, the first dielectric 16 and the second dielectric 17 are attached to the inner conductor terminals 11 lined up in the left-right direction, from above and below. Thus, the inner conductor terminals 11 are housed in the dielectric 12 (the first dielectric 16 and the second dielectric 17 in the attached state).

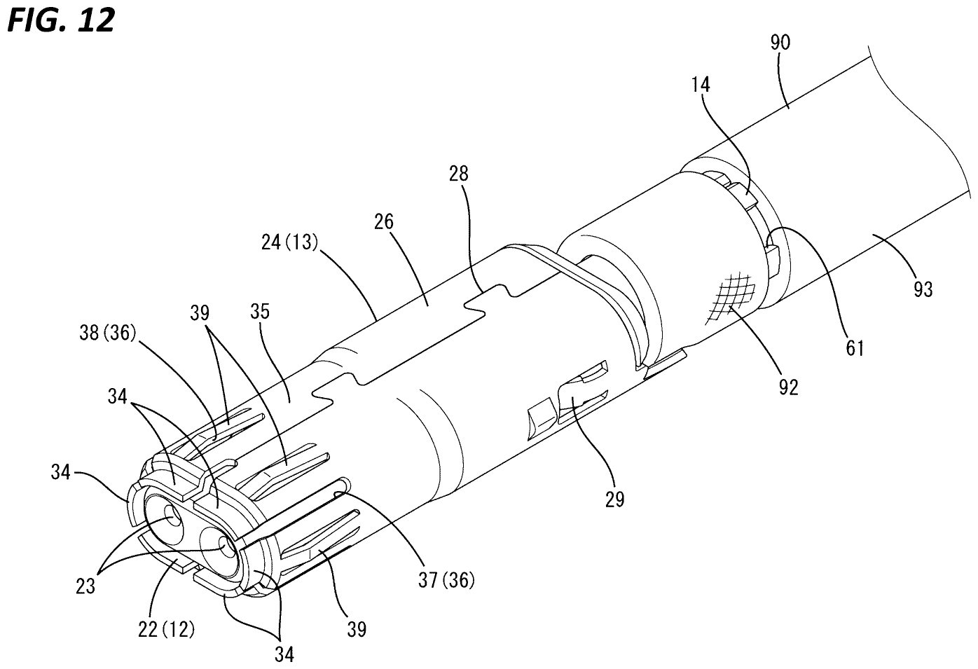

Then, as shown in FIG. 12, the dielectric 12 is inserted into the surrounding portion 26 of the first outer conductor terminal 24 from behind. The dielectric 12 is locked to the dislodgement preventing portions 29 and is housed in the first outer conductor terminal 24 in a state in which the dislodgement is prevented. Subsequently, as shown in FIG. 13, the open-shaped second outer conductor terminal 25 is disposed over the range from the rear portion of the first outer conductor terminal 24 to the front end portion of the sheath 93. In this state, as shown in FIG. 14, the second outer conductor terminal 25 is crimped and is thus allowed to surround the range from the folded-back portion 97 to the front end portion of the sheath 93. At this time, as shown in FIG. 15, the barrel pieces 55 of the first portion 44 are wound around the outer peripheral surface of the folded-back portion 97 of the shield portion 92. The barrel pieces 55 of the third portion 46 are wound around the outer peripheral surface of the sheath 93.

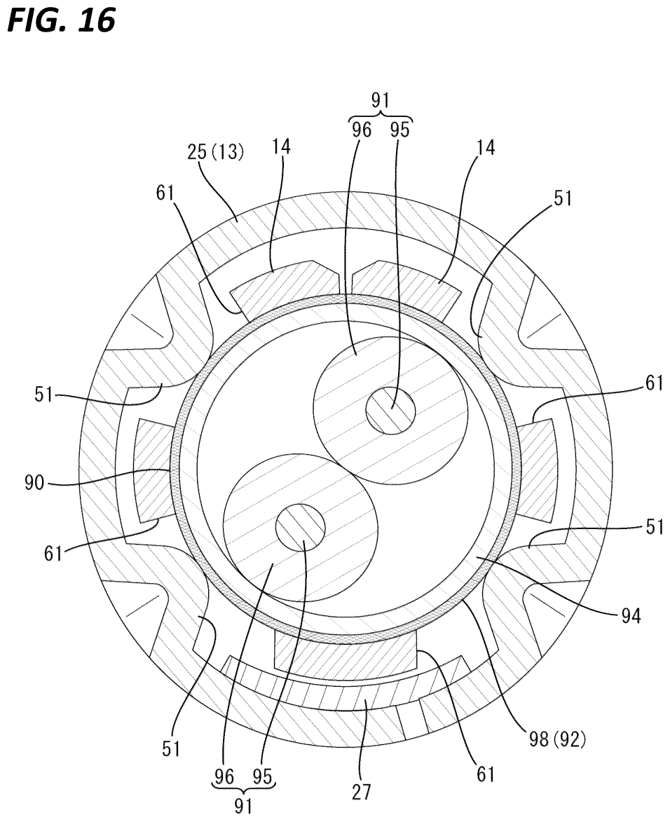

The third portion 46 is disposed at the rear end portion (including a gap that may be formed between the shield support member 14 and the sheath 93) of the shield support member 14. The barrel pieces 55 of the third portion 46 are bent along the outer peripheral surface of the rear end portion of the shield support member 14. At this time, as shown in FIGS. 15 and 16, the protrusions 51 of the third portion 46 enter the recessed portions 61 of the shield support member 14. The protrusions 51 are disposed behind the folded-back portion 97 of the shield portion 92 and are spaced apart therefrom, and are disposed so as to be in contact with or be close to the inner peripheral portion 98 of the shield portion 92. Also, the protrusions 51 are disposed in the range from the front end portion of the outer peripheral surface of the sheath 93 to the rear end portion of the shield support member 14. The front end portion of the outer peripheral surface of the sheath 93 comes into contact with and are pressed by the protrusions 51, and is thereby compressively deformed inward in the radial direction. As shown in FIG. 15, each of the protrusions 51 includes a pressing surface 65 for pressing the front end portion of the outer peripheral surface of the sheath 93, on the slope portion facing inward in the radial direction.

As shown in FIG. 15, the stopper portions 53 of the protrusions 51 are disposed so as to face the counterpart stopper portions 62 of the recessed portions 61. In Embodiment 1, the stopper portions 53 are disposed such that the surface directions of each stopper portion 53 and each counterpart stopper portion 62 intersect at an acute angle and the upper corner portion of the stopper portion 53 abuts against the intermediate portion in the vertical direction of the counterpart stopper portion 62 in a point contact manner or a line contact manner. Also, the stopper portions 53 of the protrusions 51 are disposed at intervals in the circumferential direction so as to abut against the counterpart stopper portions 62 of the recessed portions 61.

The shielded electric wire 90 is drawn rearward from the shielded terminal unit 20. When the shielded electric wire 90 is pulled rearward, a tensile force that can cause relative rearward locational shifting acts on the shield support member 14 from the second outer conductor terminal 25. However, in Embodiment 1, the relative locational shifting between the shield support member 14 and the second outer conductor terminal 25 can be prevented due to the stopper portions 53 of the second outer conductor terminal 25 abutting against the counterpart stopper portions 62 of the shield support member 14. Thus, it is possible to prevent a decrease in the region in which the third portion 46 is in contact with the folded-back portion 97 of the shield portion 92.

The protrusions 51 are formed on the third portion 46 so as to bulge therefrom, and the stopper portions 53 form the thick portions of the protrusions 51. Accordingly, even when the stopper portions 53 abut hard against the counterpart stopper portions 62, the protrusions 51 are less likely to be deformed, thus making it possible to more reliably prevent the relative locational shifting between the shield support member 14 and the second outer conductor terminal 25. Furthermore, since the third portion 46 covers a gap that can be formed between the shield support member 14 and the sheath 93, it is also possible to suppress protrusion of a part of the shield portion 92 from the second outer conductor terminal 25 during the crimping.

The shielded terminal unit 20 is housed in the fitting portion 63 of the housing 15. Before the shielded connector 10 is fitted to the counterpart shielded connector 100, the stop portions 34 face the peripheral surface portion 18 of the dielectric 12 at intervals in the radial direction in the shielded terminal unit 20. As shown in FIG. 17, when the shielded connector 10 is fitted to the counterpart shielded connector 100, the hood-shaped counterpart outer conductor terminal 123 is also fitted onto the outer peripheral surface of the first outer conductor terminal 24. At this time, the contact point portions 42 of the elastic contact portions 39 come into contact with the counterpart outer conductor terminal 123, and the elastic contact portions 39 are elastically deformed inward in the radial direction. Then, the stop portions 34 are also elastically deformed inward in the radial direction together with the elastic contact portions 39, and come into contact with the peripheral surface portion 18 of the dielectric 12 in the front-rear direction and the circumferential direction as shown in FIGS. 17 and 18. The elastic contact portions 39 are in contact with the counterpart outer conductor terminal 123 and an inward pressing force acts on the stop portions 34 in the radial direction, thus making it possible to maintain the state in which the stop portions 34 are in contact with the peripheral surface portion 18 of the dielectric 12 even when the shielded connector 10 is placed under vibration conditions.

In the state in which the shielded connector 10 is fitted to the counterpart shielded connector 100, the separation distances between the tabs 112 of the counterpart inner conductor terminals 111 and the stop portions 34 are kept constant in the front-rear direction and the circumferential direction. As a result, the characteristic impedance is also kept constant.

The front ends of the stop portions 34 protrude forward relative to the dielectric 12, and are located at the same positions as or close to a distal end surface 124 of the counterpart dielectric 122 in the front-rear direction. Here, even if the shielded electric wire 90 is, for example, pulled rearward and thus the front surface of the front wall portion 22 of the dielectric 12 is moved in a direction away from the distal end surface 124 of the counterpart dielectric 122 as shown in FIG. 17, it is possible to maintain the state in which the stop portions 34 extending to the vicinity of the distal end of the counterpart dielectric 122 cover the outer peripheral surfaces of the root portions of the tabs 112 (i.e., base end portions in a direction in which the tabs 112 protrude from the distal end surface 124). Accordingly, even if the dielectric 12 moves away from the counterpart dielectric 122, the distances between the tabs 112 of the counterpart inner conductor terminals 111 and the stop portions 34 can be kept constant as shown in FIGS. 17 and 18, thus making it possible to suppress the irregularities of the characteristic impedance.

As described above, the shielded connector 10 of Embodiment 1 includes the inner conductor terminals 11, the dielectric 12 surrounding the inner conductor terminals 11, and the plate-shaped outer conductor terminal 13 surrounding the dielectric 12. The outer conductor terminal 13 includes the plurality of elastic contact portions 39 elastically deformable in the radial direction orthogonal to the front-rear direction, and the plurality of slits 36 located between the plurality of elastic contact portions 39 in the circumferential direction of the outer conductor terminal 13. Each of the elastic contact portions 39 includes a contact point portion 42 protruding outward in the radial direction. The slits 36 extend in the front-rear direction and are open at the front end of the outer conductor terminal 13. The outer conductor terminal 13 includes, between the slits 36, the stop portions 34 that abut against the peripheral surface portion 18 of the dielectric 12 in the state in which the contact point portions 42 are in contact with the counterpart outer conductor terminal 123.

In the state in which the contact point portions 42 are in contact with the counterpart outer conductor terminal 123, the movement of the elastic contact portions 39 can be suppressed due to the stop portions 34 of the outer conductor terminal 13 abutting against the peripheral surface portion 18 of the dielectric 12, thus making it possible to maintain the distance in the front-rear direction between the counterpart inner conductor terminals 111 disposed in the space inside in the radial direction relative to the stop portions 34 and the outer conductor terminal 13. Accordingly, the amount of change in the characteristic impedance can be reduced, and the transmission characteristics can be improved. In particular, merely the stop portions 34 are formed between the slits 36 of the outer conductor terminal 13, thus making it possible to suppress an increase in cost compared with the technology described in U.S. Pat. No. 10,944,218 with which a welding seam is subjected to welding in order to reduce the amount of change in the characteristic impedance.

In the cross-sectional view taken in the front-rear direction, the stop portions 34 of Embodiment 1 have a straight shape extending in the front-rear direction. Accordingly, it is possible to effectively suppress a change in the characteristic impedance within a range of the length of the stop portions 34 extending in the front-rear direction. In addition, the stop portions 34 are in surface contact with the peripheral surface portion 18 of the dielectric 12 in the state in which the contact point portions 42 are in contact with the counterpart outer conductor terminal 123. Accordingly, even when the shielded connector 10 is placed under vibration conditions, it is possible to more reliably maintain the state in which the stop portions 34 abut against the peripheral surface portion 18 of the dielectric 12.

Each of the stop portions 34 includes a portion protruding forward relative to the dielectric 12 in the attached state. Accordingly, even when the shielded electric wire 90 is, for example, pulled rearward in the state in which the shielded connector 10 and the counterpart shielded connector 100 are fitted to each other, and a gap is formed between the dielectric 12 and the counterpart dielectric 122 in the front-rear direction, it is possible to maintain the state in which the portions of the stop portions 34 protruding forward relative to the dielectric 12 are spaced apart from one another at constant intervals and surround the outer peripheral surfaces of the counterpart inner conductor terminals 111. Accordingly, it is possible to more reliably suppress a change in the characteristic impedance between the dielectric 12 and the counterpart dielectric 122.

The shielded connector 10 according to Embodiment 1 includes the shield support member 14 that surrounds the front end portion of the shielded electric wire 90, and the outer conductor terminal 13 that is electrically connected to the shield portion 92 of the shielded electric wire 90. The shield support member 14 is held by the shielded electric wire 90. The outer conductor terminal 13 includes the first portion 44 configured to sandwich the shield portion 92 between the first portion 44 and the outer peripheral surface of the shield support member 14, the second portion 45 that surrounds the outer peripheral surface of the sheath 93 of the shielded electric wire 90, and the third portion 46 that is continuous from the first portion 44 to the second portion 45 and has a surrounding shape. The third portion 46 includes the cut holes 52 that linearly extend in the circumferential direction intersecting the front-rear direction, and the protrusions 51 that bulge inward in the radial direction of the third portion 46 behind the cut holes 52. Each of the protrusions 51 includes the stopper portion 53 that faces the counterpart stopper portion 62 of the shield support member 14 from behind.

When a rearward tensile force acts on the shielded electric wire 90, the stopper portions 53 of the protrusions 51 abut against the counterpart stopper portions 62 of the shield support member 14, thus making it possible to prevent relative locational shifting between the outer conductor terminal 13 and the shielded electric wire 90. Accordingly, it is possible to stably maintain the state in which the outer conductor terminal 13 is connected to the shield portion 92 of the shielded electric wire 90, thus making it possible to allow the outer conductor terminal 13 to have a holding force high enough to hold the shielded electric wire 90.

In particular, the stopper portions 53 bulge inward in the radial direction behind the cut holes 52 that linearly extend in the circumferential direction, in the third portion 46 that is continuous from the first portion 44 to the second portion 45 and has a surrounding shape. Accordingly, a large hole or space is not formed in the outer conductor terminal 13 due to the stopper portions 53, thus making it possible to suppress protrusion of a part of the shield portion 92 from the outer conductor terminal 13.

Since the counterpart stopper portions 62 are inclined rearward from the inside to the outside in the radial direction of the shield support member 14, it is possible to more reliably maintain the state in which the counterpart stopper portions 62 are in contact with the stopper portions 53.

Also, in Embodiment 1, the shield support member 14 includes the recessed portions 61 that are open at the rear end of the shield support member 14, and the protrusions 51 are disposed in the recessed portions 61. It is possible to determine relative positions between the outer conductor terminal 13 and the shield support member 14 due to the protrusions 51 being disposed in the recessed portions 61 as described above.

The plurality of recessed portions 61 are formed at the rear end of the shield support member 14 and are spaced apart from one another in the circumferential direction of the shield support member 14. The plurality of protrusions 51 are formed at positions corresponding to the plurality of recessed portions 61 in the third portion 46, and are spaced apart from one another in the circumferential direction of the third portion 46. With this configuration, when a rearward tensile force acts on the shielded electric wire 90, the protrusions 51 can abut against a plurality of portions of the shield support member 14, thus making it possible to more reliably prevent relative locational shifting between the outer conductor terminal 13 and the shielded electric wire 90.

Furthermore, each of the protrusions 51 includes the pressing surface 65 for pressing the front end portion of the outer peripheral surface of the sheath 93. It is also possible to prevent forward locational shifting of the shielded electric wire 90 relative to the outer conductor terminal 13 due to the pressing surfaces 65 of the protrusions 51 pressing the front end portion of the outer peripheral surface of the sheath 93 as described above.

### Other Embodiments of the Present Disclosure

Embodiment 1 above disclosed herein is exemplary in all respects, and should be construed as being not limitative.

In Embodiment 1 above, the two internal electric wires are twisted with each other to form a twisted pair wire. In contrast, another embodiment may have a configuration in which at least one internal electric wire linearly extends in the front-rear direction.

In Embodiment 1 above, the dielectric is constituted by the first dielectric and the second dielectric, which are separate members. In contrast, another embodiment may have a configuration in which a dielectric formed in one piece is used.

In Embodiment 1 above, the outer conductor terminal is constituted by the first outer conductor terminal and the second outer conductor terminal, which are separate members. In contrast, another embodiment may have a configuration in which an outer conductor terminal formed in one piece is used.

In Embodiment 1 above, each of the stop portions is formed as a portion that includes the elastic contact portion and the notch between the adjacent slits of the surrounding portion. In contrast, another embodiment may have a configuration in which each stop portion is formed as an elastic contact portion itself between the adjacent slits of the surrounding portion. It is preferable that the elastic contact portion serving as the stop portion is formed in the form of a cantilever by a slit that is open at the front end of the surrounding portion.

In Embodiment 1 above, the configuration is employed in which the stopper portions of the protrusions face and abut against the counterpart stopper portions of the recessed portions that are open at the rear end of the shield support member. In contrast, another embodiment may have a configuration in which no recessed portions are open at the rear end of the shield support member, and the stopper portions of the protrusions face and abut against a counterpart stopper portion, which is the rear end itself of the shield support member.

In Embodiment 1 above, the configuration is employed in which the stopper portions of the plurality of protrusions face and abut against the corresponding counterpart stopper portions of the shield support member. In contrast, another embodiment may have a configuration in which the stopper portion of one protrusion faces and abuts against one counterpart stopper portion of the shield support member.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector comprising:
an inner conductor terminal;
a dielectric surrounding the inner conductor terminal; and
a plate-shaped outer conductor terminal surrounding the inner conductor terminal,
wherein the outer conductor terminal includes:
a plurality of elastic contact portions elastically deformable in a radial direction orthogonal to a front-rear direction; and
a plurality of slits located between the plurality of elastic contact portions in a circumferential direction of the outer conductor terminal,
each of the plurality of electric contact portions includes a contact point portion protruding outward in the radial direction,
the plurality of slits extend in the front-rear direction and are open at a front end of the outer conductor terminal, and
the outer conductor terminal includes, between the plurality of slits, stop portions that abut against an outer peripheral surface of the dielectric while the contact point portions are in contact with a counterpart outer conductor terminal.

2. The shielded connector according to claim 1,
wherein each of the stop portions has a straight shape extending in the front-rear direction in a cross-sectional view taken in the front-rear direction.

3. The shielded connector according to claim 2,
wherein the stop portions are in surface contact with the outer peripheral surface of the dielectric while the contact point portions are in contact with the counterpart outer conductor terminal.

4. The shielded connector according to claim 1,
wherein each of the stop portions includes a portion protruding forward from a front end of the dielectric.
